(19) United States
(12) Patent Application Publication
(10) Pub. No.: US 2010/0273140 A1
(43) Pub. Date: Oct. 28, 2010

(54) APPAREL DRESSING SYSTEM AND METHOD FOR ASSISTING USER TO TRY ON APPAREL ITEM

(76) Inventor: Chun Sing Matthew Man, Hong Kong (HK)

Correspondence Address: BYIP, LTD., P.O. BOX 1484, GENERAL POST OFFICE, HONG KONG, HK

(21) Appl. No.: 12/489,493

(22) Filed: Jun. 23, 2009

Related U.S. Application Data
(60) Provisional application No. 61/171,843, filed on Apr. 23, 2009.

(51) Int. Cl. G09B 25/00; G09G 5/00; H04Q 5/22

(52) U.S. Cl. 434/371; 345/629; 340/10.6

(57) ABSTRACT

An apparel dressing system includes a display, a RFID configured for identifying a RFID tag proximate thereto and retrieving data from the RFID tag, a sensor for taking an image and/or physical parameters of the user, and a processing unit connected with the display, the RFID reader and the sensor. The RFID tag is attached to an apparel item selected by a user and contains product identification information of the apparel item. The processing unit is configured for processing the product identification information retrieved from the RFID tag and the image and/or the physical parameters of the user taken by the sensor. The processing unit is also configured for showing information related to the apparel item and the user on the display.

### CROSS-REFERENCE TO RELATED APPLICATIONS

This application claims the benefit of U.S. Provisional Application No. 61/171,843, filed on Apr. 23, 2009; the contents of which is hereby incorporated by reference.

### FIELD OF THE PATENT APPLICATION

The present invention generally relates to an apparel dressing system and more particularly to a system that utilizes radio frequency identification (RFID) technologies for assisting a user to try on an apparel item and a method for assisting a user to try on an apparel item using a radio frequency identification (RFID) system.

### BACKGROUND

RFID systems are being utilized in a multitude of applications. One of the common areas for RFID implementation is product (for inventory or for sales) identification. The bar code scanner technology is being gradually replaced by RFID technology. In a simple application, a passive RFID transponder, commonly called a tag or a card, is placed on an object that is to be identified. A RFID reader is then used to obtain information from the tag. The reader typically has a transceiver to transmit and receive signals, the transceiver being powered by a power source. The tag also has a transceiver to receive a signal from the reader and to transmit a response back to the reader. The tag is generally passive and powered by the electromagnetic field induced by the reader.

When the reader is powered on, it is configured to generate an electromagnetic field from its antenna. When the reader and the tag are within close proximity of each other, the electromagnetic field generated by the reader is coupled to the tag. The tag uses this coupled energy to power its circuitry. The reader transmits an interrogating signal to the tag, and in response the tag transmits a signal back to the reader. The tag may be placed on an item and the response from the tag may be processed to identify the item.

### SUMMARY

The present patent application is directed to an apparel dressing system. In one aspect, the apparel dressing system includes a display, a RFID configured for identifying a RFID tag proximate thereto and retrieving data from the RFID tag, a sensor for taking an image and/or physical parameters of the user, and a processing unit connected with the display, the RFID reader and the sensor. The RFID tag is attached to an apparel item selected by a user and contains product identification information of the apparel item. The processing unit is configured for processing the product identification information retrieved from the RFID tag and the image and/or the physical parameters of the user taken by the sensor. The processing unit is also configured for showing information related to the apparel item and the user on the display.

In another aspect, the apparel dressing system includes a display, a radio frequency identification (RFID) reader configured for identifying a RFID tag proximate thereto and retrieving data from the RFID tag, and a processing unit connected with the display and the RFID reader. The RFID tag is attached to an apparel item selected by a user and contains product identification information of the apparel item. The processing unit is configured for processing the product identification information retrieved from the RFID tag and showing an image of the apparel item worn by a person on the display.

The present patent application is also directed to a method for assisting a user to try on an apparel item using a RFID system. The method include the steps of retrieving product identification information of the apparel item from a RFID tag attached to the apparel item selected by the user, searching for specific product information of the apparel item in a database according the to the product identification information of the apparel item, and showing an image of the apparel item worn by a person on a display.

### BRIEF DESCRIPTION OF THE DRAWINGS

FIG. 1 is an illustrative block diagram of an apparel dressing system according to an embodiment of the present patent application.

FIG. 2A illustrates a front view of the apparel dressing system depicted in FIG. 1.

FIG. 2B illustrates a cross-sectional view of the apparel dressing system depicted in FIG. 2A.

FIG. 2C illustrates a back view of the apparel dressing system depicted in FIG. 2A.

FIG. 3 is a flowchart illustrating the operation of the apparel dressing system depicted in FIG. 1.

FIG. 4 shows the content displayed on the screen of the LCD display of the apparel dressing system depicted in FIG. 1.

FIG. 5 illustrates the apparel dressing system depicted in FIG. 1 being in connection with other systems.

FIG. 6 is an illustrative block diagram of an apparel dressing system according to another embodiment of the present patent application.

FIG. 7 illustrates the content displayed by an apparel dressing system according to yet another embodiment of the present application.

FIG. 8 illustrates the content displayed by an apparel dressing system outlining different models of an apparel item according to still another embodiment of the present application.

### DETAILED DESCRIPTION

Reference will now be made in detail to a preferred embodiment of the apparel dressing system disclosed in the present patent application, examples of which are also provided in the following description. Exemplary embodiments of the apparel dressing system disclosed in the present patent application are described in detail, although it will be apparent to those skilled in the relevant art that some features that are not particularly important to an understanding of the apparel dressing system may not be shown for the sake of clarity.

Furthermore, it should be understood that the apparel dressing system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

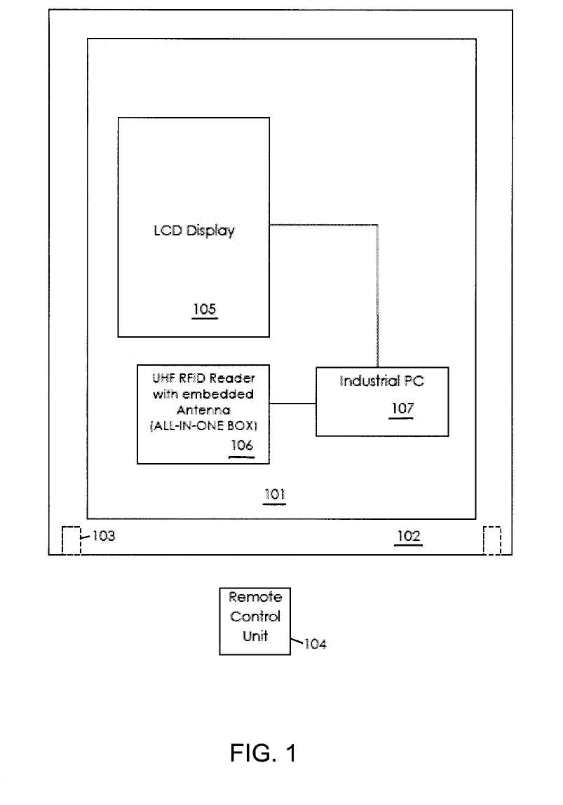

FIG. 1 is an illustrative block diagram of an apparel dressing system according to an embodiment of the present patent application. Referring to FIG. 1, the apparel dressing system includes a mirror 101, a frame 102 surrounding the mirror 101, a display 105 (a LCD display in the illustrated embodiment), an RFID reader 106 (a UHF RFID reader having an embedded antenna in the illustrated embodiment), and processing unit 107 (an industrial PC in the illustrated embodiment). The LCD display 105, the RFID reader 106 and the industrial PC 107 may be integrated with the back of the mirror 101. One or more fans (not shown in FIG. 1) can be installed on the frame 102 for cooling purpose. The RFID reader 106 is covered by a small piece of material that UHF electromagnetic waves can transmit through, so that RFID tags proximate to the apparel dressing system can be detected. In this embodiment, a small glass plate may be used to cover the RFID reader 106. The apparel dressing system may also include small wheels 103 for mobility purposes and a remote control unit 104 for a user to remotely control the apparel dressing system. A network port (not shown in FIG. 1) may be provided on the industrial PC 107 for data communication with external systems. The RFID reader 106 may be connected to the industrial PC 107 through a USB (Universal Serial Bus) connection or a network.

In operation, the RFID reader 106, controlled by the processor of the industrial PC 107, is configured to detect any RFID tags proximate thereto and interrogate the tags for retrieving data from the RFID tags. The RFID reader 106 is configured to send the data it retrieves from the RFID tags to the industrial PC 107. The industrial PC 107 is configured to continuously monitor any change in the data.

The industrial PC 107 handles data filtering of enormous tag information through a built-in application engine. Three standard functional modules may be installed in the industrial PC 107, namely middleware engine for filtering data for necessary and desired information, a data storage pool for storing the large volume of data, and an application engine for analyzing and processing the data and presenting the results on the LCD display. The data storage pool is also available and accessible by external systems through a network connection.

The remote control unit 104 is configured for navigating through the displayed content on the LCD display 105 by interacting with and controlling the industrial PC 107. The LCD display 105 may be connected to the industrial PC 107 through a connector, such as a VGA DB-15 connector. An optional RFID antenna may be connected to the RFID reader 106. The two small wheels 103 may be provided so that it is convenient to move the mirror 101.

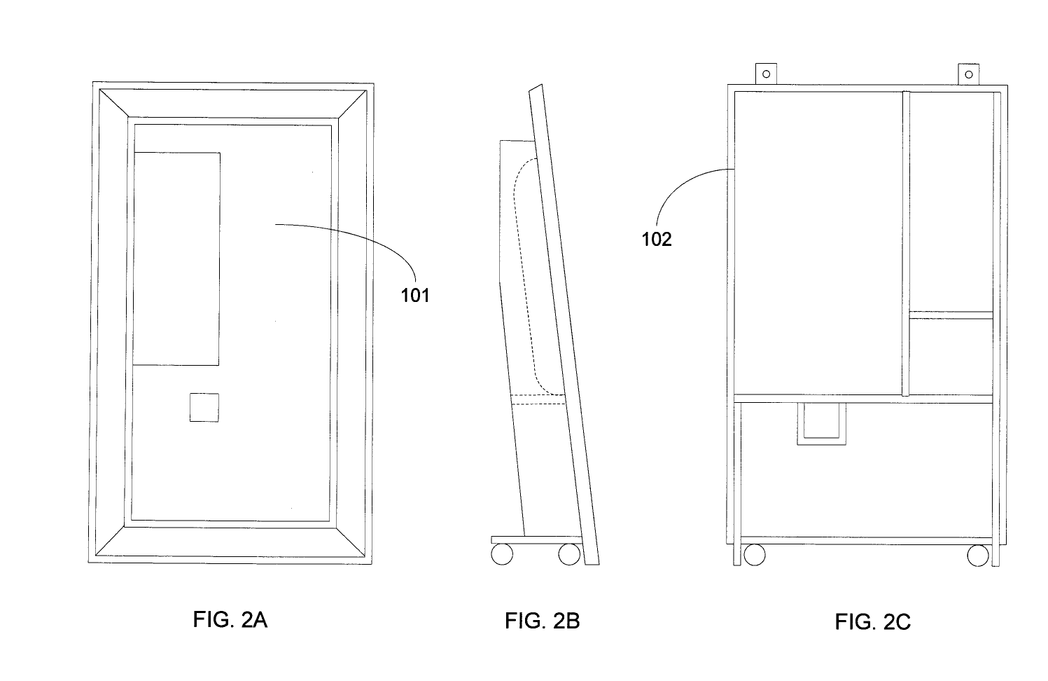

FIG. 2A illustrates a front view of the apparel dressing system depicted in FIG. 1. FIG. 2B illustrates a cross-sectional view of the apparel dressing system. FIG. 2C illustrates a back view of the apparel dressing system. Referring to FIGS. 2A-2C, the frame 102 may be made of metal and supported by multiple metal bars at the back so that a skeleton of the frame 102 is safely maintained. The mirror 101 is designed to be placed in a tilting angle against a wall upon fixture.

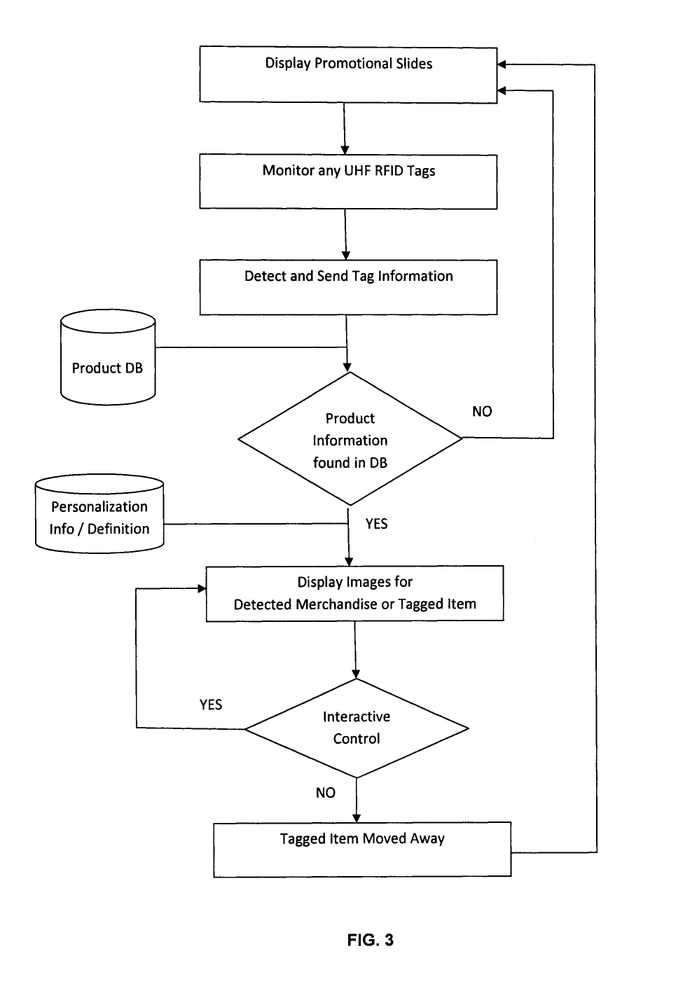

FIG. 3 is a flowchart illustrating the operation of the apparel dressing system depicted in FIG. 1. In this embodiment, an RFID tag is used to store a unique product identifier for an apparel item in an apparel store environment. The RFID reader is used to detect and read the tag information so that the detected apparel item is recognized. Each apparel item is associated with an RFID tag.

Initially, promotional slides can be continuously displayed on the LCD display. The RFID reader will monitor if any RFID tags are detected. In other words, the RFID reader will detect if any apparel item with a RFID tag is brought in front of the mirror by a customer. When a tag is detected, the tag information is read and sent to the industrial PC for further processing. If the product information can be found in a product information database, then the interactive features to promote the apparel items will be invoked. The features are designed in an interactive approach which allows the customer to interact with the mirror. The interactive features can be any predetermined or customer-provided video/movie clips, sound effects, designers' recommendations, product introduction, mixing/matching photos, auto size-matching, dressing size variation information and etc.

The interactive features can be displaying a series of pictures of recommended items that can be worn along with the detected apparel item. The multimedia contents such as audio and video clips related to the apparel item can be displayed on the LCD display at the same time. An example of audio contents can be a brief design idea by a fashion designer related to the detected apparel item. An example of the video can be a short movie for this apparel item being worn by a model on a fashion show. All the multimedia content associated with the apparel item is defined in the product information database. While the pictures to promote the apparel items are displayed, the customer can use the remote control unit to interact with the apparel dressing system by pausing at a particular picture that she/he likes while it is being displayed on the LCD display, and navigate forward or backward in the queue of the pictures from that point. When the apparel item is brought away from the mirror and the tag thereon can no longer be detected by the RFID reader, the LCD display goes back to display the original promotional slides.

The illustrated embodiment also allows personalization by providing templates for the users to define their preferred screen layouts on the display, including for example the specific locations to place the pictures and the video clips. A rolling message is displayed at the bottom of the screen. The RFID reader can also recognize the identity of a user if the user carries a preregistered user RFID card, such as a VIP (very important person) card or a customer card, in which case a greeting message customized to the user can be displayed on the LCD display.

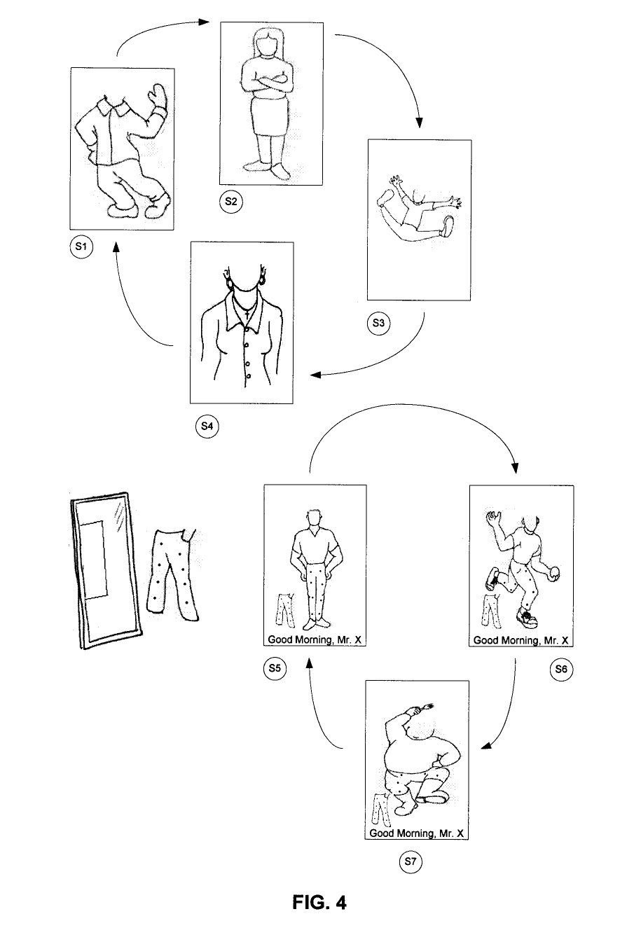

As an illustration, FIG. 4 shows the content displayed on the screen of the LCD display in this embodiment. Initially when no apparel item with an RFID tag is detected, the promotional slides are continuously displayed on the LCD display. Pictures S1, S2, S3 and S4 are the promotional slides/pictures created by the apparel store. These pictures are displayed in turn continuously. When an apparel item with an RFID tag is brought in front of the mirror, the RFID tag will be detected by the apparel dressing system. If the corresponding product information can be found in the product information database, the interactive features to promote this particular apparel item will be invoked, replacing the current S1, S2, S3, S4 slides on the display. In this illustration, the pictures of the apparel item worn by a model will be displayed showing different looks and feels of the item under different circumstances, which may include a standing posture as shown in S5, a running posture as shown in S6, and a stepping posture in shown S7. Slides of different postures are displayed continuously in turn while the RFID tag of the apparel item is still under detection. The customer can use the remote control unit to interact with the mirror, pausing on a particular picture she/he likes, such as S5, S6 or S7, while the picture is displayed on the LCD display, or navigating forward or backward in the picture queue from that point.

In this embodiment, there can be a greeting message displayed on the screen. It takes place when the customer carries a preregistered user RFID card (such as a VIP card) so that the apparel dressing system can detect the card and identify the person. The greeting message is customized to the recognized identity of this person. As shown in FIG. 4, if the customer is identified as “Mr. X” by the VIP card he is carrying with him, a message “Good morning, Mr. X” is displayed at the bottom of the display. Other information customized to this person can also be displayed on the screen. For example, if the apparel dressing system stores portrait photos and the physical parameters (such as height, width, body size, etc.) of the recognized customer in the database, the slides S5, S6 and S7 can be illustrative pictures of this particular customer wearing the apparel item selected by him with different postures. To achieve this, a computer program searches pictures of a human body wearing that apparel item in the database where the physical parameters of the human body in the pictures match those of the particular customer. A photo editing program then combines the customer's portrait photos with pictures of the human body wearing that apparel item. The pictures having this particular customer wearing the apparel item selected by him are then generated. The pictures of human bodies with different physical parameters wearing different apparel items can be created by using computer graphics software or by editing real photos.

When the apparel item with the tag is brought away from the mirror, the promotional slide show is revoked again and hence S1, S2, S3 and S4 are again displayed in turn.

It is noted that in this embodiment the picture slides and the messages are customized to the individual customers and thereby direct the customer's experience and his or her perception of the apparel item to an individual level.

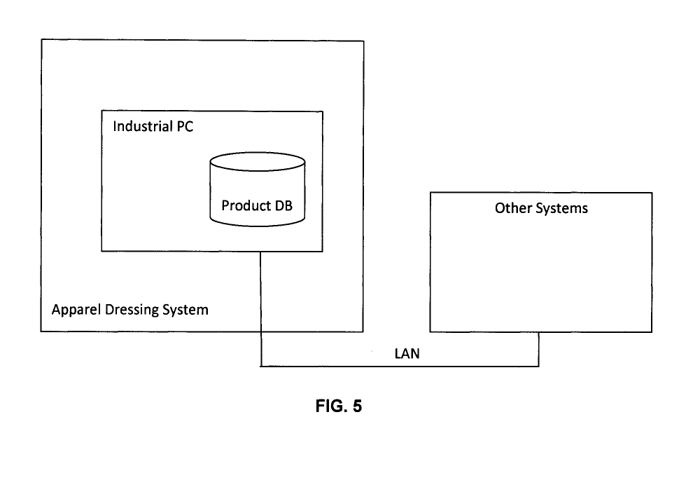

FIG. 5 illustrates the apparel dressing system depicted in FIG. 1 being in connection with other systems. Referring to FIG. 5, the apparel dressing system provided by this embodiment is not limited to working as a standalone system, but may also provide real time data to other systems via a network. All the information about the detected tags will be stored in the industrial PC with timestamps. If any user wants to use this set of real time data, the user can connect an external systems to the apparel dressing system provided by this embodiment through a network and retrieve the real time information of the tags for further processing.

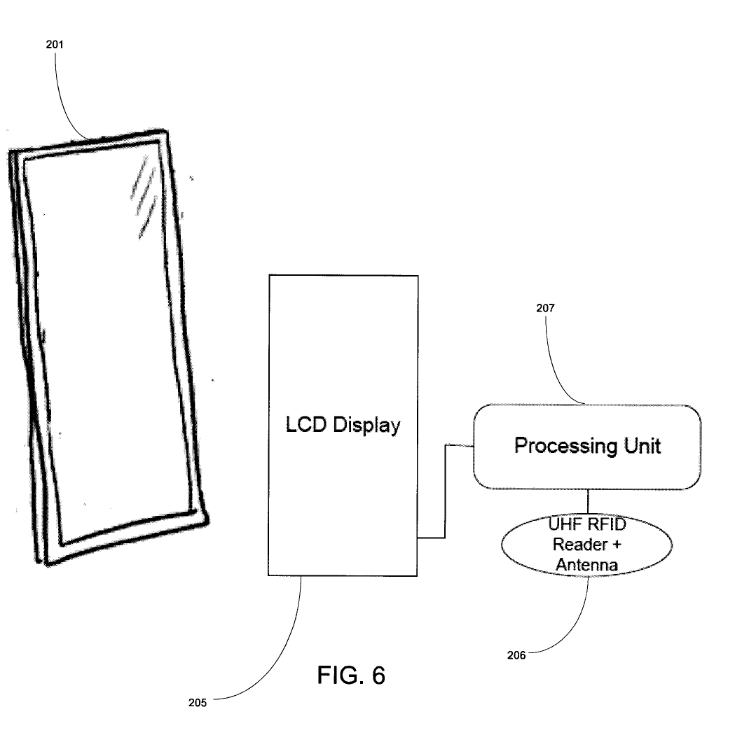

FIG. 6 is an illustrative block diagram of an apparel dressing system according to another embodiment of the present patent application. In this embodiment, the apparel dressing system includes a RFID system and a mirror 201, the RFID system being separated from the mirror 201. The RFID system includes a RFID reader 206 (a UHF RFID reader in the illustrated embodiment) for detecting RFID tags, a display 205 (a LCD display in the illustrated embodiment), and a processing unit 207 (such as a computer) connecting to the RFID reader 206 and the LCD display 205. The mechanism of operation for this embodiment is essentially the same as that of the embodiment depicted in FIG. 1. When a tagged apparel item is detected by the RFID system, the interactive features to promote the apparel items will be invoked. The interactive features can be any customer preferred video/movie clips or sound effects, designers' recommendations for wearing the apparel item, product introduction, mixing/matching photos and so on. The customers can also use a remote control unit (not shown in FIG. 6) that is included by the apparel dressing system to interactively control the content being displayed. The mirror 201 can be any kind of mirror for general fitting and testing purposes.

It is to be understood that the apparel dressing system described above may include just the display, the RFID reader, and the processing unit. The processing unit can be remote from the display, and the mirror may be optional.

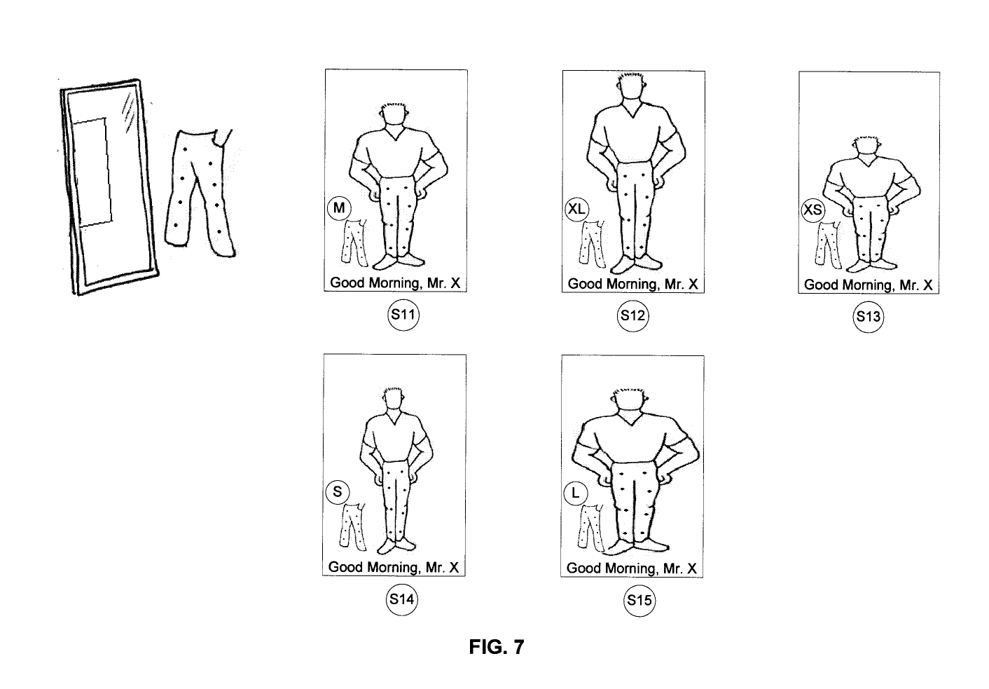

FIG. 7 illustrates the content displayed by an apparel dressing system according to yet another embodiment of the present application. Comparing with the embodiment depicted by FIG. 6, in this embodiment, the apparel dressing system further includes a sensor connected to the processing unit. In the illustrated embodiment, the sensor is an image sensor. The sensor is configured to take pictures of a customer and/or make certain measurements on the customer. Such measurement may be made on the physical parameters (such as height, width, body size, etc.) of the customer for facilitating the apparel fitting process. It is understood that such measurements are derived from calculations by the processing unit based on the images or physical parameters taken by the image sensor and therefore may be approximate. A promotion picture of this apparel item in a size that best matches the measurements worn by a model that physically resembles the customer will be displayed on the LCD display. It reflects the almost real look-and-feel of the customer dressing the apparel item and gives a realistic idea to the customer when she/he wears the apparel item. In FIG. 7, S11, S12, S13, S14 and S15 are respectively pictures showing models with different heights and widths wearing the apparel item of different sizes. These pictures are all stored in the apparel dressing system as part of the product information and only the one that best matches the measurements on the customer will be displayed each time. An adequate size specification is provided along with each picture slide so that the customer knows the best-fit size he or she should try.

It is understood that if the database of the apparel dressing system has stored the customer's photos and physical parameters (such as height, width, body size, etc.) beforehand, pictures and/or videos of the customer himself or herself wearing the apparel item can be shown on the LCD display. To achieve this, a computer program searches pictures and/or videos of a human body wearing that apparel item in the database where the physical parameters of the human body in the pictures match those of the customer. A photo/video editing program then combines the customer's photos with pictures and/or videos of the human body wearing that apparel item. The pictures and/or videos having this particular customer wearing the apparel item selected by him are then generated. The pictures and/or videos of human bodies with different physical parameters wearing different apparel items can be created by using computer graphics software or by editing real photos and/or videos.

It is also understood that in this embodiment, the sensor is configured to take photos of a customer and/or make certain measurements on the customer. Such measurement may be made on the physical parameters (such as height, width, body size, etc.) of the customer. The processing unit of the system then processes the photos just taken by the sensor and physical parameters of the customer, and pictures and/or videos of the customer himself or herself wearing the apparel item are shown on the LCD display. To achieve this, a computer program searches pictures and/or videos of a human body wearing that apparel item in the database where the physical parameters of the human body in the pictures match those of the customer. A photo/video editing program then combines the customer's photos with pictures and/or videos of the human body wearing that apparel item. The pictures and/or videos having this particular customer wearing the apparel item selected by him are then generated. The LCD display in this embodiment effectively becomes a “virtual” mirror to the customer. The real mirror as included in previous embodiments can be eliminated.

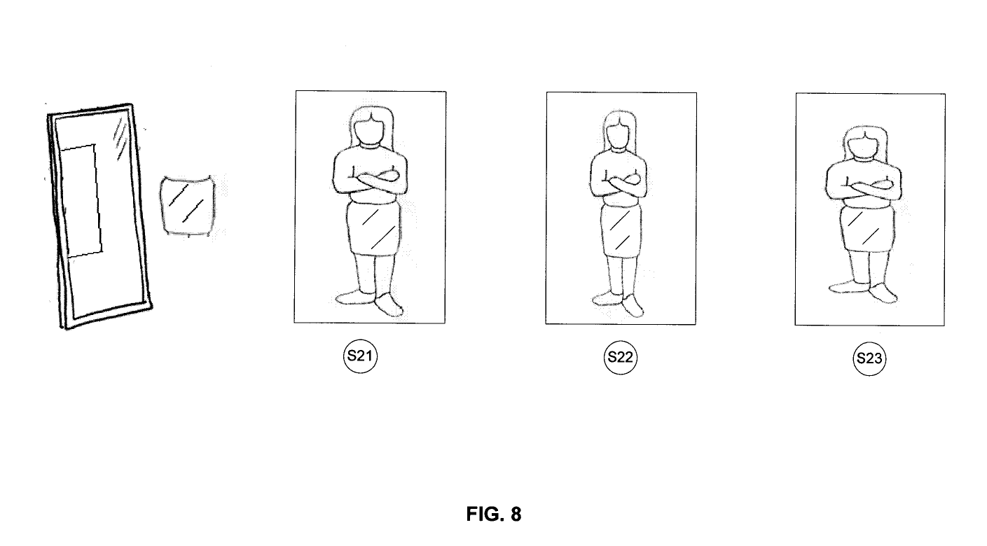

FIG. 8 illustrates the content displayed by an apparel dressing system outlining different models of an apparel item according to still another embodiment of the present application. When a tagged apparel item is detected by the apparel dressing system, pictures of different models of the apparel item, for example, models with different sizes, are displayed on the LCD display in turn. Referring to FIG. 8, the large size, medium size and small size models of a skirt as respectively shown in pictures S21, S22 and S23 are displayed in the LCD in turn. It gives the customers an impression on the look-and-feel of the skirt of different available sizes. The customer can also use the remote control unit to navigate the screen display to view the different sizes of the apparel item and the corresponding effects.

While the present patent application has been shown and described with particular references to a number of embodiments thereof, it should be noted that various other changes or modifications may be made without departing from the scope of the present invention.

What is claimed is:

1. An apparel dressing system comprising:
a display;
a radio frequency identification (RFID) reader configured for identifying a RFID tag proximate thereto and retrieving data from the RFID tag, the RFID tag being attached to an apparel item selected by a user and containing product identification information of the apparel item;
a sensor for taking an image and/or physical parameters of the user; and
a processing unit connected with the display, the RFID reader and the sensor, the processing unit configured for processing the product identification information retrieved from the RFID tag and the image and/or the physical parameters of the user taken by the sensor, and configured for showing information related to the apparel item and the user on the display.

2. The apparel dressing system of claim 1, further comprising a database storing product information of various apparel items, wherein the processing unit is configured to search for the specific product information of the apparel item selected by the user in the database and show at least some of the specific product information of the apparel item on the display.

3. The apparel dressing system of claim 2 wherein the specific product information of the apparel item shown on the display comprises an image of the apparel item worn by a model.

4. The apparel dressing system of claim 2, wherein the database stores user information of various users, the RFID reader is configured to retrieve data from a preregistered user RFID card carried by the user, and the processing unit is configured to search for specific user information of the user in the database according to the data retrieved from the preregistered user RFID card and show the user wearing the apparel item on the display.

5. The apparel dressing system of claim 4, wherein specific user information of the user comprises an image of the user, and wherein the processing unit comprises a program configured to search for an image of a human body wearing the apparel item in the database and combine the image of the user with the image of the human body.

6. The apparel dressing system of claim 2, wherein the processing unit is configured to process the image and/or the physical parameters of the user taken by the sensor and show the user wearing the apparel item on the display.

7. The apparel dressing system of claim 6, wherein the processing unit comprises a program configured to search for an image of a human body wearing the apparel item in the database where the physical parameters of the user match those of the human body wearing the apparel item, and a program configured to combine the image of the user taken by the sensor with the image of the human body.

8. The apparel dressing system of claim 2, wherein the processing unit is configured to process the physical parameters of the user taken by the sensor and show a model wearing the apparel item where the physical parameters of the user match those of the model.

9. The apparel dressing system of claim 1, further comprising a database storing user information of various users, wherein the RFID reader is configured to retrieve data from a preregistered user RFID card carried by the user, and the processing unit is configured to search for specific user information of the user in the database according to the data retrieved from the preregistered user RFID card and show at least some of the specific user information on the display.

10. The apparel dressing system of claim 1, further comprising a mirror for the user to look on when the user is trying on the apparel item, wherein the display is integrated with the mirror.

11. The apparel dressing system of claim 1, further comprising a remote control for the user to remotely control the processing unit and thereby control the content being displayed on the display.

12. An apparel dressing system comprising:
a display;
a radio frequency identification (RFID) reader configured for identifying a RFID tag proximate thereto and retrieving data from the RFID tag, the RFID tag being attached to an apparel item selected by a user and containing product identification information of the apparel item; and
a processing unit connected with the display and the RFID reader, the processing unit configured for processing the product identification information retrieved from the RFID tag and showing an image of the apparel item worn by a person on the display.

13. The apparel dressing system of claim 12, further comprising a database storing product information of various apparel items, wherein the processing unit is configured to search for the specific product information of the apparel item selected by the user in the database according to the data transmitted from the RFID reader.

14. The apparel dressing system of claim 13, wherein the database stores user information of various users, wherein the RFID reader is configured to retrieve data from a preregistered user RFID card carried by the user, and the processing unit is configured to search for specific user information of the user in the database according to the data retrieved from the preregistered user RFID card and show the user wearing the apparel item on the display.

15. The apparel dressing system of claim 14, wherein specific user information of the user comprises an image of the user, and wherein the processing unit comprises a program configured to search for an image of a human body wearing the apparel item in the database and combine the image of the user with the image of the human body.

16. The apparel dressing system of claim 12, further comprising a database storing user information of various users, wherein the RFID reader is configured to retrieve data from a preregistered user RFID card carried by the user, and the processing unit is configured to search for specific user information of the user in the database according to the data retrieved from the preregistered user RFID card and show at least some of the specific user information on the display.

17. The apparel dressing system of claim 12, further comprising a mirror for the user to look on when the user is trying on the apparel item, wherein the display is integrated with the mirror.

18. The apparel dressing system of claim 12, further comprising a remote control for the user to remotely control the processing unit and thereby control the content being displayed on the display.

19. A method for assisting a user to try on an apparel item using a radio frequency identification (RFID) system, comprising:
retrieving product identification information of the apparel item from a RFID tag attached to the apparel item selected by the user;
searching for specific product information of the apparel item in a database according the to the product identification information of the apparel item; and
showing an image of the apparel item worn by a person on a display.

20. The method for assisting a user to try on an apparel item of claim 19, further comprising:
retrieving data from a preregistered user RFID card carried by the user;
searching for specific user information of the user in the database according to the data retrieved from the preregistered user RFID card; and
showing the user wearing the apparel item on the display.

21. The method for assisting a user to try on an apparel item of claim 19, further comprising:
taking an image and/or physical parameters of the user by a sensor;
searching for an image of a human body wearing the apparel item in the database where the physical parameters of the user match those of the human body wearing the apparel item;
combining the image of the user taken by the sensor with the image of the human body; and
showing the user wearing the apparel item on the display.

22. The method for assisting a user to try on an apparel item of claim 19, further comprising:
taking physical parameters of the user by a sensor;
processing the physical parameters of the user taken by the sensor; and
showing a model wearing the apparel item where the physical parameters of the user match those of the model.
